(19) United States
(12) Patent Application Publication
(10) Pub. No.: US 2026/0155513 A1
(43) Pub. Date: Jun. 4, 2026

(54) LOAD BEARING BATTERY PACK

(71) Applicant: Our Next Energy, Inc., Novi, MI (US)

(72) Inventors: Vignesh Sekar, Farmington Hills, MI (US); Huzaifa Moiz Rahim, Farmington Hills, MI (US)

(73) Assignee: Our Next Energy, Inc., Novi, MI (US)

(21) Appl. No.: 19/406,346

(22) Filed: Dec. 2, 2025

Related U.S. Application Data
(60) Provisional application No. 63/727,324, filed on Dec. 3, 2024.

(51) Int. Cl. H01M 50/233; B60L 50/64; H01M 50/209; H01M 50/262; H01M 50/271

(52) U.S. Cl. CPC H01M 50/233; B60L 50/64; H01M 50/209; H01M 50/262; H01M 50/271; H01M 2220/20

(57) ABSTRACT

A battery pack for an electric vehicle configured to transfer a tensile load, such as from a seat restraint system, through the battery pack to underlying vehicle structure includes a battery tray, a plurality of prismatic electrochemical cells arranged in major face-to-major face relationship, and at least one flanged beam having a web located between adjacent cells and at least one flange at an upper end of the web on which a battery pack lid is secured.

### CROSS-REFERENCE TO RELATED APPLICATIONS

This application claims priority to U.S. Provisional Application No. 63/727,324, filed Dec. 3, 2024, which is incorporated herein by reference in its entirety.

### FIELD OF THE DISCLOSURE

This disclosure relates generally to electrical vehicle battery packs, and more particularly to battery packs configured to transfer a tensile load through the battery pack to underlying vehicle structure.

### BACKGROUND OF THE DISCLOSURE

Passenger car electric vehicles are often designed to apply tensile loads from seat restraints onto the lid of a battery pack. In such cases, the battery pack must be designed to achieve adequate management of the tensile loads while maximizing volumetric energy density in the battery pack. Known solutions have involved relying exclusively on structural adhesives to manage transfer of tensile loads through a battery pack or adding structural cross members that occupy space that would otherwise be occupied by electrolytic cells. These known solutions exhibit reliability and robustness challenges and/or reduced volumetric energy density.

### SUMMARY OF THE DISCLOSURE

The disclosed battery packs utilize flanged beams to transfer tensile loads through the battery pack in a volume efficient manner that minimally reduces the volume energy density of the battery pack.

The battery packs described in this disclosure have a battery tray, a plurality of prismatic electrochemical cells located on the battery tray in face-to-face relationship, and at least one flanged beam having a web disposed between adjacent cells and at least one flange at an upper end of the web opposite a lower end of the web fixed to the tray.

In some embodiments, the beam is an I-beam, and in some embodiments, the beam is a T-beam. The at least one flanged beam can be fixed to the tray with a weld or with a structural adhesive.

The upper flange can have a nub, which may be threaded, to facilitate attachment of a battery pack lid to the beam(s).

In some embodiments, the lid can be provided with a seat restraint anchor to transfer a tensile load to the lid, then to the beam(s), and then to the tray.

### BRIEF DESCRIPTION OF THE DRAWINGS

FIG. 1 is a perspective view of a battery pack in accordance with this disclosure with a portion of the battery pack (except for the beams) broken away to show a perspective cross-section.

FIG. 2 is a cross-sectional view of the battery pack shown in FIG. 1.

FIG. 3 is a cross-sectional view of an alternative battery pack in which the beams are welded to the tray.

### DETAILED DESCRIPTION

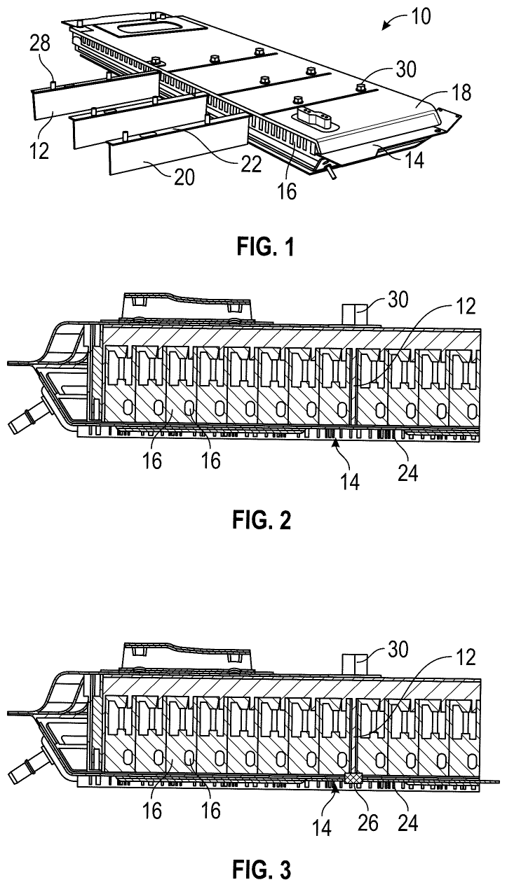

Shown in FIG. 1 is a battery pack 10 for use in an electrical vehicle, which includes one or more flanged voidless structural beams 12 to efficiently transfer tensile loads from seat restraints disposed above the battery pack to a battery tray 14. Tray 14 constitutes the bottom of the battery pack housing on which a plurality of prismatic electrochemical cells 16 are adjacently arranged. Each cell 16 has opposite major faces (i.e., the largest faces) which are aligned with and contact or nearly contact the major face of adjacent cells (except for end cells which have only one major face adjacent the major face of an adjacent cell). A battery pack lid 18 cooperates with tray 14 to define an enclosure for cells 16.

Flanged voidless structural beams 12 may have either a single flange 22 at one end of the web 20 defining a T-beam or a flange 22 at each opposite end of web 20 defining an I-beam. A bottom end of each of the one or more flanged voidless structural beams 12 is fixed to the battery tray 14. Each of the one or more flanged voidless structural beams 12 is located between the major faces of two otherwise adjacent cells 16, contacting or nearly contacting the major faces of the adjacent cells 16. In order to optimize the strength to volume ratio of the structural beams 12, the beams 16 are comprised of a single generally continuous web 20 that is not bent or folded to define a void volume. Rather, beams 16 are voidless. However, while not necessarily preferred, web 20 can have holes.

As illustrated in FIGS. 2 and 3, cells 16 can be secured to tray 14 with a structural adhesive 24. Similarly, a lower end of beam 12 can be secured to tray 12 using the same (or different) structural adhesive 24. Alternatively, the lower end of beam 12 can be secured to tray 14 with a weld 26 (FIG. 3).

Beam 12, tray 14 and lid 18 can be fabricated from metals, such as aluminum, stainless steel or carbon steel, from fiber (e.g., glass fibers or carbon fibers) reinforced composites, or hard plastics (e.g., polypropylene).

The upper face of flange 22 of beam 12 generally abuts a lower surface of lid 18 when pack 10 is fully assembled. Threaded nubs 28 may project upwardly away from the upper face of flange 22 and through a corresponding opening of lid 18 when pack 10 is fully assembled. Lid 18 can be secured to beams 12 with nuts 30.

Lid 18 can be provided with a seat restraint anchor for receiving a tensile load from a seat restraint system and transferring the load through lid 18 and beams 12 to tray 14, which can further transfer the tensile load to underlying vehicle structure.

While the present invention is described herein with reference to illustrated embodiments, it should be understood that the invention is not limited hereto. Those having ordinary skill in the art and access to the teachings herein will recognize additional modifications and embodiments within the scope thereof. Therefore, the present invention is limited only by the claims attached herein.

1. An electric vehicle battery pack comprising:
a battery tray;
a plurality of prismatic electrochemical cells disposed on the battery tray, each prismatic electrochemical cell having opposite major faces, the plurality of prismatic electrochemical cells arranged adjacently in major face to major face relationship; and
at least one flanged voidless structural beam having a bottom end fixed to the battery tray, the flanged voidless structural beam disposed between two of the adjacent prismatic electrochemical cells.

2. The electric vehicle battery pack of claim 1, wherein the flanged voidless structural beam has a T-shape with a single flange at an upper end of the beam that is opposite the bottom end fixed to the battery tray.

3. The electric vehicle battery pack of claim 1, wherein the flanged voidless structural beam has an I-shape with a first flange at an upper end of the beam that is opposite the bottom end of the beam and a second flange at the bottom end of the beam.

4. The electric vehicle battery pack of claim 1, wherein the flanged voidless structural beam is fixed to the battery tray with a weld.

5. The electric vehicle battery pack of claim 1, wherein the flanged voidless structural beam is fixed to the battery tray with a structural adhesive.

6. The electric vehicle battery pack of claim 2, further comprising a nub projecting upwardly away from the single flange to facilitate securement of a battery pack lid to the nub with a nut.

7. The electric vehicle battery pack of claim 6, wherein the nub is threaded to facilitate securement of the lid to the nub with a nut.

8. The electric vehicle battery pack of claim 3, further comprising a nub projecting upwardly away from the first flange to facilitate securement of a battery pack lid.

9. The electric vehicle battery pack of claim 8, wherein the nub is threaded to facilitate securement of the lid to the nub with a nut.

10. The electric vehicle battery pack of claim 7, wherein a seat restraint anchor is provided on the lid.

11. The electric vehicle battery pack of claim 9, wherein a seat restraint anchor is provided on the lid.

12. The electric vehicle battery pack of claim 1, wherein the plurality of prismatic electrochemical cells are secured to the battery tray with a structural adhesive.
